(19) United States
(12) Patent Application Publication
(10) Pub. No.: US 2008/0232683 A1
(43) Pub. Date: Sep. 25, 2008

(54) Image processing apparatus, image processing method and computer program product

(75) Inventors: Hitoshi Itoh, Tokyo (JP); Shinji Yamakawa, Kanagawa (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 12/071,143

(22) Filed: Feb. 15, 2008

(30) Foreign Application Priority Data
Mar. 19, 2007 (JP) 2007-070718

(51) Int. Cl. G06K 9/34

(52) U.S. Cl. 382/164

(57) ABSTRACT

An image processing apparatus includes a first separator, a second separator, a dividing unit, and a generating unit. The first separator separates image data into character image data and other image data. The second separator separates the character image data into shape image data and color image data. The dividing unit divides the shape image data and the color image data based on a dividing size decided from the size of the image data and the capacity of processing memory used in output processing of the image data. The generating unit generates additional information for combining a corresponding pair of divided shape image data and divided color image data with the other image data.

### CROSS-REFERENCE TO RELATED APPLICATIONS

The present application claims priority to and incorporates by reference the entire contents of Japanese priority document 2007-070718 filed in Japan on Mar. 19, 2007.

### BACKGROUND OF THE INVENTION

1. Field of the Invention

The present invention relates to an image processing apparatus, an image processing method, and a computer program product.

2. Description of the Related Art

Opportunities to handle color images are increasing as color printers become more popular and, for example, high-resolution scanners and digital cameras become more widespread. This, however, is causing file sizes to increase. Image compression methods such as defined by Joint Photographic Experts Group (JPEG) can therefore be used to reduce file size.

High-compression portable document format (PDF) technology is also well-known. The high-compression PDF technology is capable of implementing compression rates in excess of the compression rates of JPEG with high image quality for color images. In this technology, high compression is achieved by separating data into images and characters etc. within the image data based on image characteristics. Compression processing is then carried out for each separated image according to the respective characteristics.

Japanese Patent Publication No. 3707586 has proposed a conventional technology capable of processing in divided image units by dividing images separated into photographs and character strings into a plurality of band regions (divided images) of a width corresponding to image characteristics. The divided images can then be combined to give one item of image data. This combining is carried out based on additional information describing information such as arrangement position etc. for each divided image generated at the time of dividing.

However, it is necessary to expand an amount of information corresponding to each separated image in the memory to combine separated images into a single item of image data. The amount of information handled at one time therefore becomes large. This means that separated and compressed color images cannot be reproduced by equipment where memory capacity is limited.

Further, analysis of the entire image data is required for the conventional technology because dividing of the width takes place into a number of dividing regions in accordance with image characteristics. Time is therefore required for this processing. Moreover, with the conventional technology, the number of divided images becomes large because all of the divided images making up the color image are disassembled and the amount of data for additional information required at the time of recombining becomes substantial. This increases file sizes which in turn hinders high compression.

### SUMMARY OF THE INVENTION

It is an object of the present invention to at least partially solve the problems in the conventional technology.

According to an aspect of the present invention, there is provided an image processing apparatus that includes an input unit that inputs image data; a deciding unit that decides a dividing size from a size of the image data and capacity of processing memory used in output processing of the image data; a first separator that separates the image data into character image data including a character image and other image data including other image other than the character image; a second separator that separates the character image data into shape image data denoting shape of the character image and color image data denoting color of the character image; a dividing unit that divides the shape image data and the color image data based on the dividing size and creates a plurality of divided shape image data and a plurality of divided color image data; and a generating unit that generates additional information for combining a corresponding pair of divided shape image data and divided color image data with the other image data.

According to another aspect of the present invention, there is provided an image processing method including inputting image data; deciding a dividing size from a size of the image data and capacity of processing memory used in output processing of the image data; separating the image data into character image data including a character image and other image data including an image other than the character image; separating the character image data into shape image data denoting shape of the character image and color image data denoting color of the character image; dividing the shape image data and the color image data based on the dividing size and creates a plurality of divided shape image data and a plurality of divided color image data; and generating additional information for combining a corresponding pair of divided shape image data and divided color image data with the other image data.

According to still another aspect of the present invention, there is provided a computer program product that implements the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an image processing apparatus according to a first embodiment of the present invention;

FIG. 2 is a schematic diagram for explaining the operation of an image content separator shown in FIG. 1;

FIGS. 3 and 4 are schematic diagrams for explaining the operation of a color/shape divider shown in FIG. 1;

FIG. 5 is a schematic diagram for explaining the operation of a compressed data generator shown in FIG. 1;

FIG. 6 is a flowchart of compressed-data generation processing according to the first embodiment;

FIG. 7 is a functional block diagram of the image processing apparatus for combining separated/divided images according to the first embodiment;

FIG. 8 is a flowchart of a procedure for separated/divided image combining processing according to the first embodiment;

FIG. 9 is a block diagram of an image processing apparatus according to a second embodiment of the present invention;

FIGS. 10 and 11 are schematic diagrams for explaining the operation of an image selector shown in FIG. 9;

FIG. 12 is a flowchart of compressed-data generation processing according to the second embodiment;

FIG. 13 is a detailed flowchart of image selection processing shown in FIG. 12;

FIG. 14 is a functional block diagram of the image processing apparatus for combining separated/divided images according to the second embodiment;

FIG. 15 is a flowchart of a procedure for separated/divided image combining processing according to the second embodiment; and

FIG. 16 is a block diagram of a hardware configuration of the image processing apparatus.

### DETAILED DESCRIPTION OF THE PREFERRED EMBODIMENTS

Exemplary embodiments of the present invention are explained in detail below with reference to the accompanying drawings. Examples are shown in the following embodiments applied to an image processing apparatus. However, application of the present invention is by no means limited to the image processing apparatus, and application to personal computers (PCs), image reading devices, and information equipment such as copiers and printers is also possible.

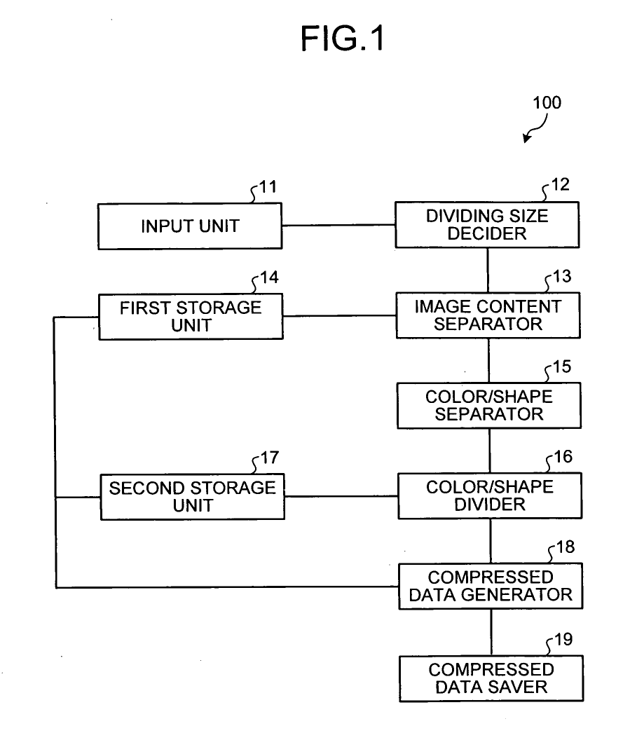

FIG. 1 is a block diagram of an image processing apparatus 100 according to a first embodiment of the present invention. The image processing apparatus 100 includes an input unit 11, a dividing size decider 12, an image content separator 13, a first storage unit 14, a color/shape separator 15, a color/shape divider 16, a second storage unit 17, a compressed data generator 18, and a compressed data saver 19.

The input unit 11 is a functional unit corresponding to an engine 120, described later, and includes a reading unit (not shown) for optically reading in an image such as manuscripts, and acquires image data corresponding to the image as an input image. The input unit 11 can also include an auto document feeder (ADF) for automatically feeding originals to the reading unit in a consecutive manner. The input unit 11 can be an interface, etc. that is capable of connecting with other equipment and acquires image data input from the other equipment as an input image.

The dividing size decider 12 decides dividing size during dividing of images into color and shape images based on the memory capacity of memory the image processing apparatus 100 is provided with. Specifically, the dividing size decider 12 decides the size (height and width) in a dividing direction for divided color image data and divided shape image data based on a memory capacity B (MBytes) of processing memory such as a random access memory (RAM) 102b the image processing apparatus 100 is provided with using a relational expression shown in Equation (1). In Equation (1), a color image is a 24-bit color image, and a shape image is a binary image (one bit of information for one pixel).

B×1024×8=24×height×width+height×width÷8 (1)

In Equation (1), the left side means a conversion of the units for the memory capacity from Mbytes to Bytes, the first term on the right side is a color image term, and the second term on the right side is a shape image term. Further, in Equation (1), one of either the height or width is a value decided uniquely from the size of the image data. It is then possible to calculate height at the time of dividing as shown in Equation (2) in the case of dividing in, for example, the height direction. The case of dividing in the width direction is also the same.

height≈338×B (2)

The value substituted as the memory capacity B in Equations (1) and (2) is taken to be the total memory capacity of a holding unit (a divided color image holder 24 and a divided shape image holder 26) holding divided color image data and divided shape image data at the time of combining separation/divided images of the processing memory (the RAM 102b).

The relational expression for deciding dividing size is not limited to Equation (1). For example, it is also possible to use an equation including an item that defines memory capacity of data for other images on the right side of Equation (1). In this case, the value substituted as the memory capacity B is taken to be the total memory capacity of an other image holder 22, the divided color image holder 24 and the divided shape image holder 26 of the total memory capacity of the processing memory (the RAM 102b).

The image content separator 13 analyzes input images acquired by the input unit 11 and separates the input images into character image data of character images and other image data of other images. The term “character image” as used herein refers to a text portion where characters are represented as an image and a diagrammatic portion, and are taken to not include a character portion represented by character codes. The term “other image” as used herein refers to a photographic portion, etc. Known technology such as algorithms used for character recognition and for digital watermarks, and used in falsification detection can be used as an algorithm for separating the input image into character image data and other image data.

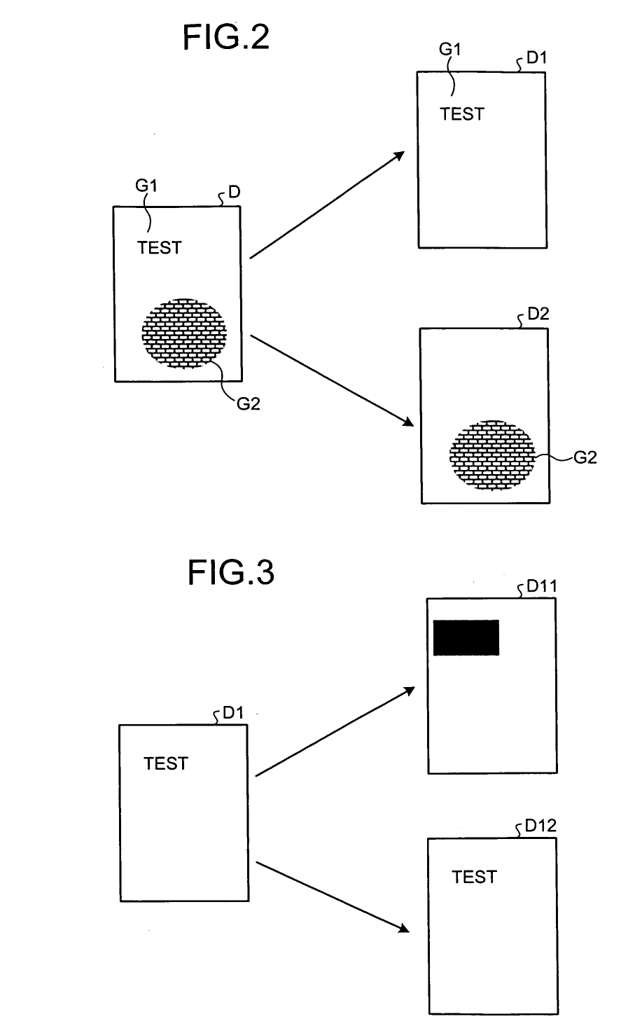

FIG. 2 is a schematic diagram for explaining the operation of the image content separator 13. As shown in FIG. 2, the image content separator 13 separates a single input image D containing a character image G1 and an other image G2 into character image data D1 of the character image and other image data D2 of the other image.

The first storage unit 14 corresponds to a read only memory (ROM) 102a, a local memory (MEM-C) 107, and a hard disk drive (HDD) 108, described later, that stores therein the other image data separated by the image content separator 13.

The color/shape separator 15 analyzes character image data separated by the image content separator 13 and separates the character images into color image data and shape image data denoting shapes (outlines) of character images. The resolution of the shape image data is required to be the same resolution as the input image but the resolution of the color image data can be converted to a resolution lower than the resolution of the input image.

FIG. 3 is a schematic diagram for explaining the operation of the color/shape separator 15. As shown in FIG. 3, the color/shape separator 15 separates a character image portion of the character image data D1 into color image data D11 on the color of a character image, and shape image data D12 on the shape of the character image. The separated color image data D11 and shape image data D12 are separated in such a manner that enables reproduction of the original character image data D1 as a result of image processing (mask processing) by a combining unit 27.

The color/shape divider 16 generates a number of items of divided color image data by dividing color image data separated by the color/shape separator 15 into a number of band regions based on a dividing size decided by the dividing size decider 12. Further, the color/shape divider 16 generates a number of items of divided shape image data by dividing shape image data separated by the color/shape separator 15 into a number of band regions based on a dividing size decided by the dividing size decider 12.

The color/shape divider 16 generates respective additional information indicating arrangement positions for each item of divided color image data (band region) occurring at regions for the original color image data i.e. regions for other image data during generation of divided color image data. The additional information is correlated with corresponding divided color image data and stored in the second storage unit 17. The color/shape divider 16 generates respective additional information indicating arrangement positions for each item of divided shape image data (band region) occurring at regions for the original shape image data i.e. regions for other image data during generation of divided shape image data. The additional information is correlated with corresponding divided shape image data and stored in the second storage unit 17.

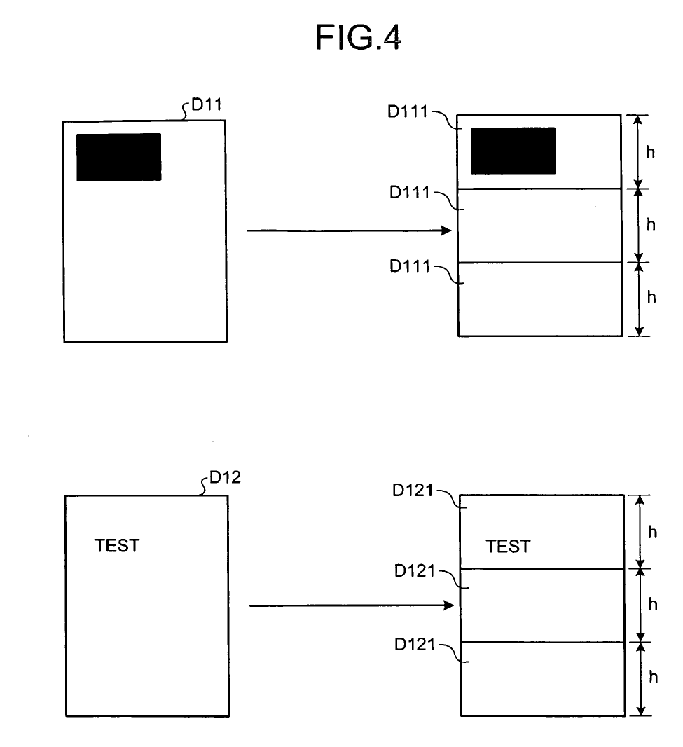

FIG. 4 is a schematic diagram for explaining the operation of the color/shape divider 16. As shown in FIG. 4, the color/shape divider 16 separates the color image data D11 and the shape image data D12 every dividing size h decided by the dividing size decider 12 and respectively generates divided color image data D111 including band regions and divided shape image data D121. In FIG. 4, an example is shown where the color image data D11 and the shape image data D12 are divided in the height direction.

The second storage unit 17 is the ROM 102a, the MEM-C 107 and the HDD 108 that stores divided color image data and divided shape image data divided by the color/shape divider 16.

The compressed data generator 18 reads out other image data stored in the first storage unit 14 and divided color image data and divided shape image data stored in the second storage unit 17 and reduces file size by subjecting each item of data to predetermined compression processing.

For example, the file size is reduced using a compression method such as JPEG on other image data. Reduction in file size is also achieved by reducing the number of colors for the divided color image data or by using compression methods such as FLATE. The file size of the divided shape image data is reduced using compression methods such as joint bi-level image experts group (JBIG). The compression method can be reversible compression or non-reversible compression. It is also possible to not perform compression processing.

The compressed data generator 18 generates a single item of compressed data (compressed PDF, JPM (JPEG 2000 Part 6), etc.) describing combining information for combining each item of data, together with each item of data after compression.

The combining information is information indicating the layout positions (layout) of character image data (divided color image data, divided shape image data) at the other image data and is described based on additional information correlated to each item of divided color image data and divided shape image data. It is possible to reproduce display conditions for originally input images as a result of each item of divided color image data and divided shape image data being arranged at the other image data based on combining information during reproduction of the compressed data.

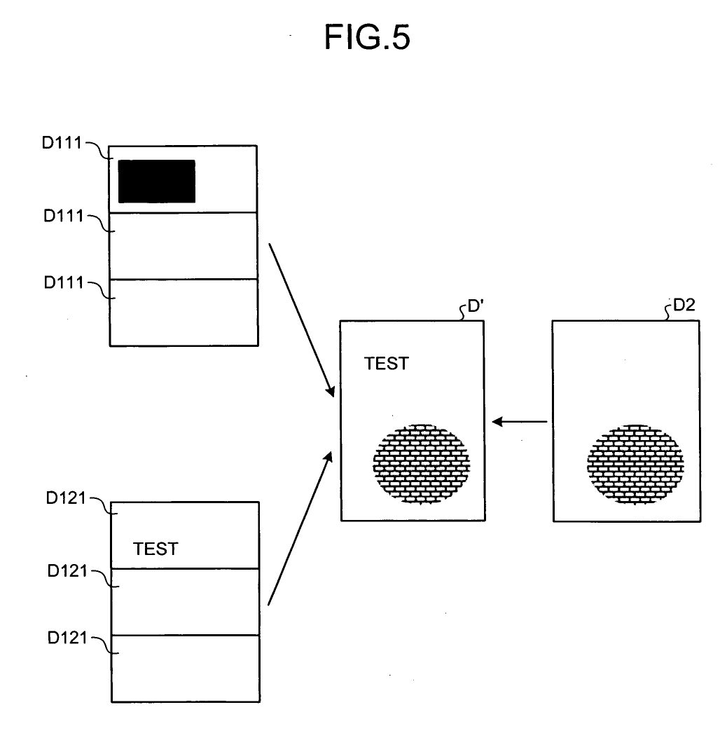

FIG. 5 is a schematic diagram for explaining the operation of the compressed data generator 18. As shown in FIG. 5, the compressed data generator 18 reads out the other image data D2 stored in the first storage unit 14, and color image data D11 (divided color image data D111) and shape image data D12 (divided shape image data D121) stored in the second storage unit 17. The compressed data generator 18 subjects each item of divided color image data D111 and divided shape image data D121 to compression processing and then generates one item of compressed data D′ that is capable of reproducing the originally input image D.

The compressed data saver 19 is a storage unit such as the HDD 108 that stores compressed data generated by the compressed data generator 18.

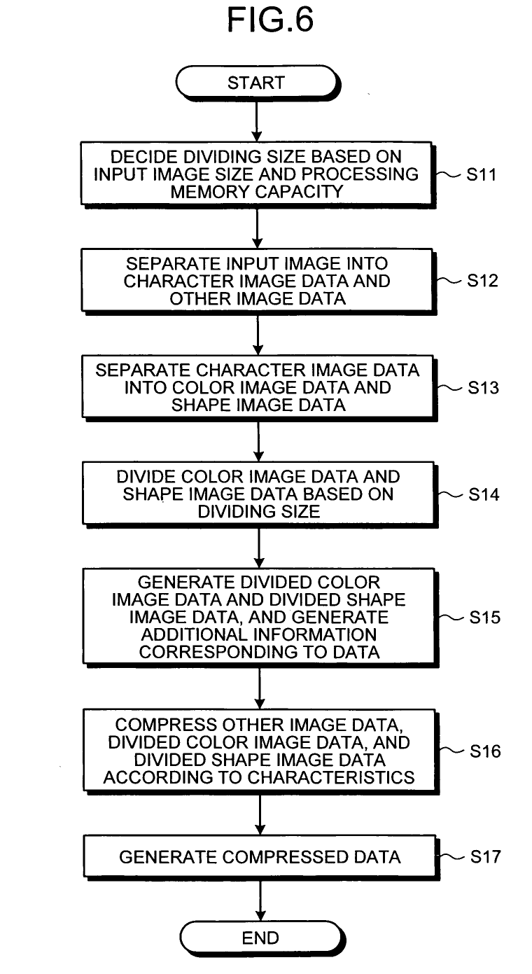

FIG. 6 is a flowchart of compressed-data generation processing performed by the image processing apparatus 100.

First, when an input image is acquired by the input unit 11, the dividing size decider 12 decides the dividing size based on the height and width of the input image and the available memory capacity of processing memory the image processing apparatus 100 itself is provided with (step S11).

Next, the image content separator 13 separates the input image into character image data of character images and other image data of other images (step S12). The color/shape separator 15 separates the character image data into color image data and shape image data (step S13).

The color/shape divider 16 divides the color image data and the shape image data based on the dividing size decided at step S11 (step S14). A plurality of items of divided color image data and divided shape image data are then generated and additional information corresponding to each item of data is generated (step S15).

The compressed data generator 18 then reduces the file size of each item of data by implementing predetermined compression processing according to the characteristics of the other image data, the divided color image data, and the divided shape image data (step S16). One item of compressed data is then generated describing combining information for combining each item of data after compression together with each item of data (step S17), and this processing is complete.

Of the character image data and the other image data making up the image data, the character image data is divided into shape image data and color image data. The shape image data and the color image data are then divided up using a dividing size corresponding to the memory capacity of the processing memory. It is then possible to restrict the number of divided images and suppress increases in the amount of additional information.

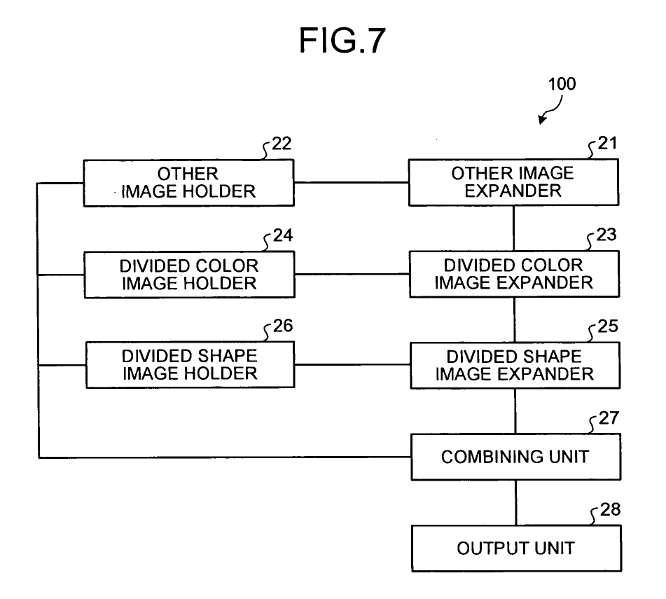

Next, combining of the separated/divided images (other image data, divided color image data, and divided shape image data) is explained. FIG. 7 is a functional block diagram of the image processing apparatus 100 for combining separated/divided images.

As shown in FIG. 7, the image processing apparatus 100 includes, as functional structures for combining separated/divided images, an other image expander 21, the other image holder 22, a divided color image expander 23, the divided color image holder 24, a divided shape image expander 25, the divided shape image holder 26, the combining unit 27, and an output unit 28.

The other image expander 21 reads out other image data stored in the first storage unit 14 and expands the other image data on the processing memory at the other image holder 22. The other image holder 22 is a storage region on the processing memory such as the RAM 102b described later that temporarily stores other image data expanded by the other image expander 21.

The divided color image expander 23 sequentially reads out divided color image data stored in a series in the second storage unit 17 and sequentially expands the divided color image data on the divided color image holder 24 on the processing memory. The divided color image holder 24 is a storage region on the processing memory such as the RAM 102b described later that temporarily stores divided other image data expanded by the divided color image expander 23.

The divided shape image expander 25 sequentially reads out divided shape image data stored in a series in the second storage unit 17 and sequentially expands the divided color image data on the divided shape image holder 26 on the processing memory. The divided shape image holder 26 is a storage region on the processing memory such as the RAM 102b described later that temporarily stores divided shape image data expanded by the divided shape image expander 25.

The divided color image data and the divided shape image data expanded at the divided color image holder 24 and the divided shape image holder 26, respectively, are generated using dividing sizes corresponding to the memory capacity of the processing memory. Processing can therefore be carried out effectively without the occurrence of insufficient memory, etc.

The combining unit 27 restores the originally input image by referring to divided shape image data expanded at the divided shape image holder 26, and sequentially overwriting pixels for divided color image data expanded at the divided color image holder 24 over other image data expanded at the other image holder 22. The combining unit 27 overwrites other image data with each item of divided shape image data and divided color image data based on additional information stored to correlate each item of divided color image data and divided shape image data.

The output unit 28 outputs input images restored by the combining unit 27 and can include, for example, a display device or a printer engine of the engine 120.

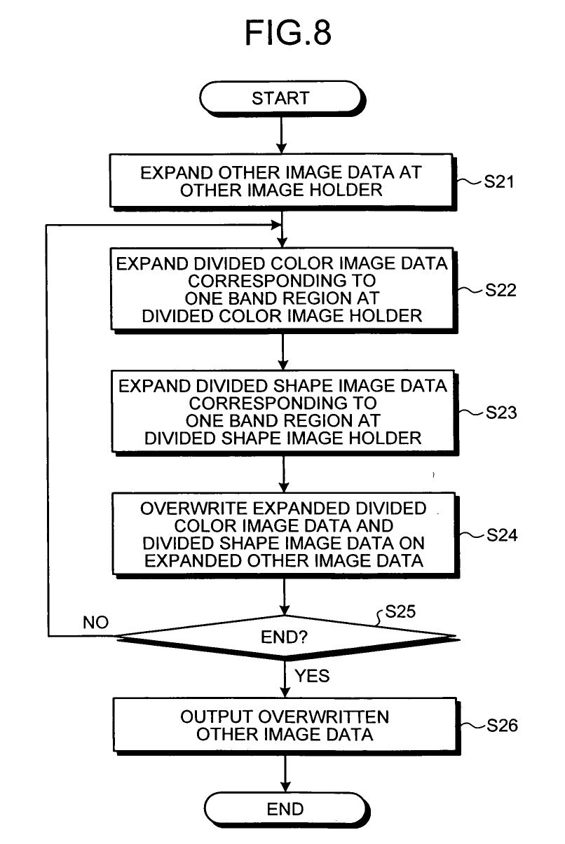

FIG. 8 is a flowchart of a procedure for separated/divided image combining processing performed by the image processing apparatus 100.

First, the other image expander 21 reads out other image data stored in the first storage unit 14 and expands the other image data at the other image holder 22 (step S21).

Next, the divided color image expander 23 reads out divided color image data corresponding to one band region from a series of divided color image data stored in the second storage unit 17 for expansion on the divided color image holder 24 on the processing memory (step S22). The divided shape image expander 25 reads out one item of divided shape image data corresponding to the one band region from the plurality of items of divided shape image data stored in series in the second storage unit 17 and expands the data on the divided shape image holder 26 (step S23).

The combining unit 27 then refers to the divided shape image data expanded at the divided shape image holder 26, and overwrites the other image data expanded at the other image holder 22 with pixels of the divided color image data expanded at the divided color image holder 24 (step S24). At step S25, the combining unit 27 determines whether processing is carried out for all the regions making up the other image data. When it is determined that an unprocessed region exists (No at step S25), step S22 is returned to, and divided color image data and divided shape image data corresponding to the next band region are read out by the divided color image expander 23 and the divided shape image expander 25.

On the other hand, when the combining unit 27 determines that processing is carried out for all the regions making up the other image data (Yes at step S25), the output unit 28 outputs the other image data the divided color image data and the divided shape image data are overwritten on (step S26), and this processing ends.

As described above, according to the first embodiment, the character image data of the character image data and the other image data making up the image data is separated into shape image data and color image data. The shape image data and the color image data are then divided up using a dividing size corresponding to the memory capacity of the processing memory. As a result, it is possible to restrict the number of divided images without it being necessary to analyze all of the image data and it is possible to handle separated and divided image data even with equipment having limited memory capacity. It is therefore possible to carry out more effective processing on image data.

Separated/divided images stored in the first storage unit 14 and the second storage unit 17 are taken as the processing target in combining separated/divided images but this is by no means limiting, and separated/divided images stored in the external device of the image processing apparatus 100 may also be taken as a target of processing.

Further, separated/divided images where compression is complete contained in the compressed data may be taken as the processing target in the combining of separated/divided images. In this case, it is possible to reproduce the display conditions for the originally input image by overwriting the divided color image data and the divided shape image data on the other image data based on combining information described in the compressed data.

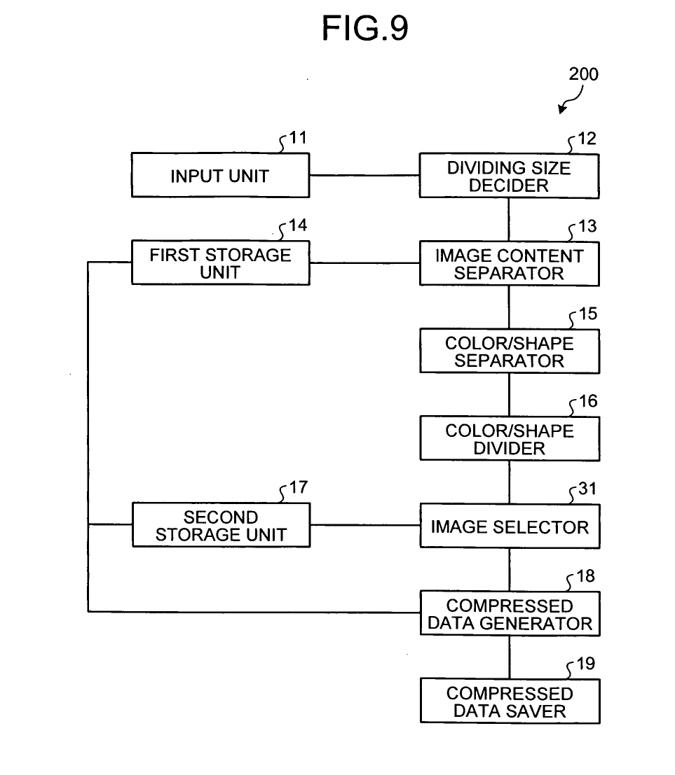

FIG. 9 is a block diagram of an image processing apparatus 200 according to a second embodiment of the present invention. The image processing apparatus 200 is of configuration basically similar to the image processing apparatus 100 except for an image selector 31. The same numerals are given to structural elements that are the same as for the first embodiment and a description of the elements is omitted.

The image selector 31 determines whether divided shape image data is necessary and chooses divided color image data and divided shape image data based on the state of pixels contained in the divided shape image data generated by the color/shape divider 16.

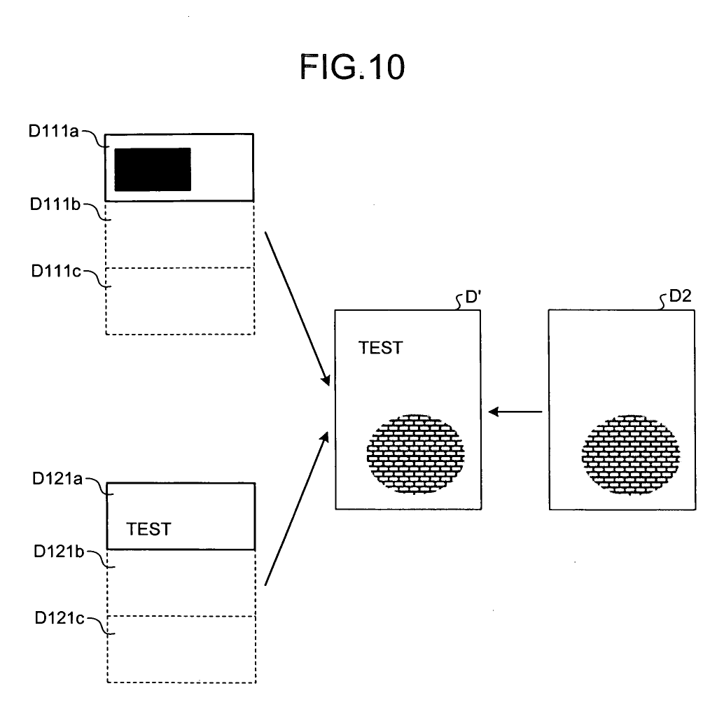

As shown in FIG. 10, when it is determined that there are no pixels in the divided shape image data, i.e. when it is determined at all of the binary values expressing the shape image for the whole band of the divided shape image data are all zero (when “0” indicates “white”) for the separated shape data, the image selector 31 determines that this is unnecessary data because no operation is performed at the time of combining with other image data. Divided color image data corresponding to the divided shape image data determined to be unnecessary data is also determined to be unnecessary data because no operations take place when combining with other image data.

FIG. 10 depicts the operation of the image selector 31. As shown in FIG. 10, the image selector 31 determines divided shape image data D121b, D121c that does not include pixels of the divided shape image data D121 (D121a to D121c) to be unnecessary data. The image selector 31 also determines divided color image data D111b, D111c corresponding to the divided shape image data D121b, D121c of the divided color image data D111 (D111a to D111c) to be unnecessary data.

Divided color image data D111b and D111c, and divided shape image data D121b and D121c determined to be unnecessary by the image selector 31 is deleted from the structural elements of the compressed data when compressed data is generated by the compressed data generator 18. The compressed data generator 18 then generates one item of compressed data D′ that is capable of reproducing the display state of the originally input image D from the divided color image data D111a, divided shape image data D121a and the other image data D2.

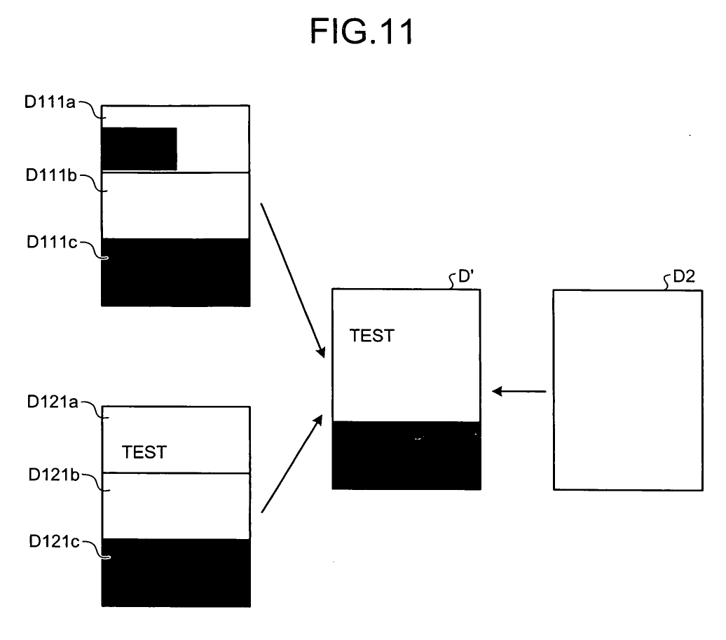

As shown in FIG. 11, when it is determined that there are no pixels included in the whole region for the divided shape image data, i.e. when it is determined that all of the binary values expressing the shape image for the whole band of the divided shape image data are “1” (when “1” indicates “black”) for the separated shape data, the image selector 31 determines that this is unnecessary data because this data is redundant at the time of synthesis with the divided color image data (during mask processing).

FIG. 11 depicts the operation of the image selector 31. As shown in FIG. 11, the image selector 31 determines divided shape image data D121c that includes pixels for the whole region of the divided shape image data D121 (D121a to D121c) to be unnecessary data.

Divided color image data D111c determined to be unnecessary by the image selector 31 is similarly deleted from the structural elements of the compressed data when compressed data is generated by the compressed data generator 18. The compressed data generator 18 then generates one item of compressed data D′ that is capable of reproducing the originally input image D from the divided color image data D111, divided shape image data D121a and D121b, and the other image data D2.

The image selector 31 then stores divided color image data and the divided shape image data determined to be unnecessary data in a manner correlating unnecessary information indicating to this effect. It is also possible to remove divided color image data and divided shape image data itself that is determined to be unnecessary data with correlation as unnecessary information being stored in the additional information designating the position of arrangement of the band region for the divided color image data and the divided shape image data.

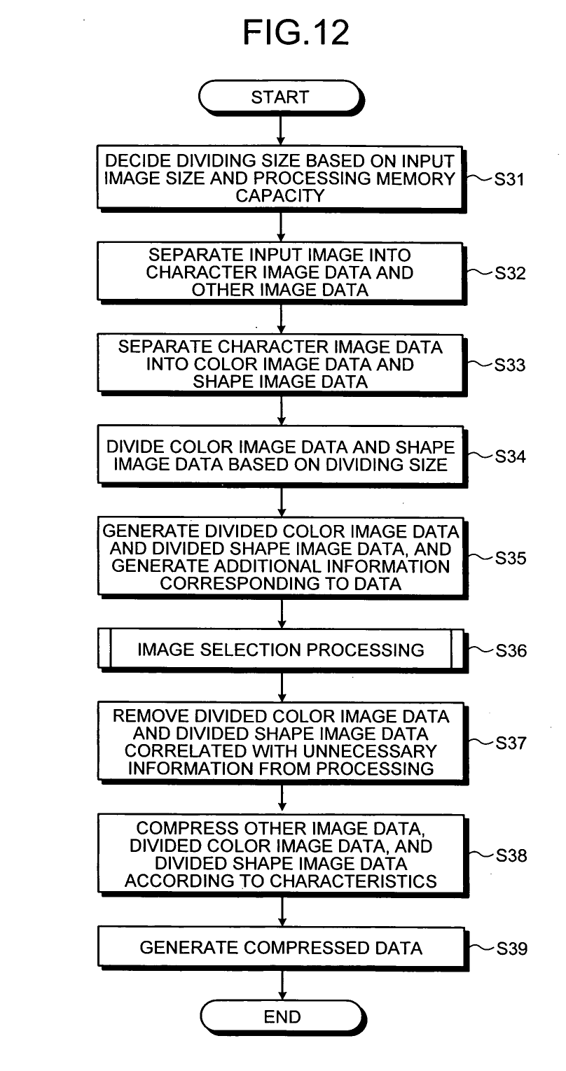

FIG. 12 is a flowchart of compressed-data generation processing performed by the image processing apparatus 200.

First, when an input image is acquired by the input unit 11, the dividing size decider 12 decides the dividing size based on the height and width of the input image and the available memory capacity of processing memory the image processing apparatus 100 itself is provided with (step S31).

Next, the image content separator 13 separates the input image D into character image data of character images and other image data of other images (step S32). The color/shape separator 15 separates the character image data into color image data and shape image data (step S33).

The color/shape divider 16 divides the color image data and the shape image data based on the dividing size decided at step S21 (step S34). A plurality of items of divided color image data and divided shape image data are then generated and additional information corresponding to each item of data is generated (step S35).

Next, the image selector 31 performs image selection processing based on the state of pixels expressing the character shapes contained in the divided shape image data generated at step S35 (step S36).

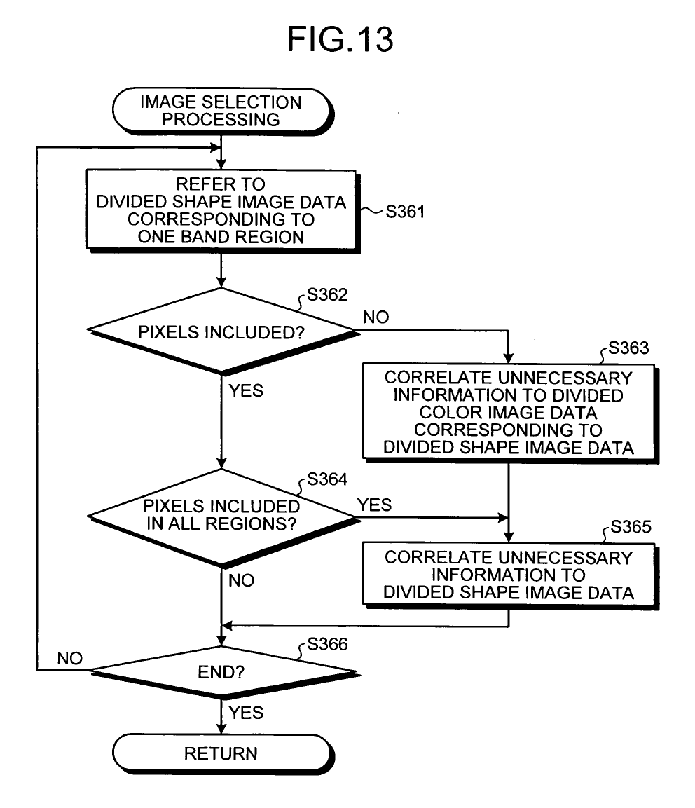

FIG. 13 is a detailed flowchart of the image selection processing performed at step S36 in FIG. 12. First, the image selector 31 refers to divided shape image data corresponding to one band region of the plurality of divided shape image data generated at step S35 (step S361). It is then determined whether pixels expressing character shapes are included in the divided shape image data (step S362).

When it is determined that such pixels are not included in the divided shape image data (No at step S362), the image selector 31 determines divided color image data corresponding to band regions of this divided shape image data to be unnecessary data and correlates the data as unnecessary information (step S363). The image selector 31 then determines this divided shape image data to be unnecessary data and proceeds to step S366 after correlating the data as unnecessary information (step S365).

On the other hand, when such pixels are contained in the divided shape image data (Yes at step S361), the image selector 31 determines whether all regions of the divided shape image data include any of the pixels (step S364). Step S366 is proceeded to immediately when not all the regions contains any of the pixels (No at step S364).

When all the regions contains any of the pixels (Yes at step S364), the image selector 31 determines that this divided shape image data is unnecessary data. After correlating the unnecessary information (step S365), step S366 is proceeded to.

At step S366, the image selector 31 determines whether processing has been carried out for all the band regions. When an unprocessed band region exists (No at step S366), step S361 is again returned to, and the divided shape image data corresponding to the next band region is referred to.

On the other hand, when the image selector 31 determines that processing is carried out for all the band regions (Yes at step S366), step S37 of FIG. 12 is proceeded to.

Returning to FIG. 12, the compressed data generator 18 removes data determined as unnecessary data at step S36, i.e., divided color image data and divided shape image data with unnecessary information, from being the target of processing (step S37). The compressed data generator 18 then respectively reduces the file size of each item of data (step S38) by subjecting the other image data separated at step S32, divided color image data and divided shape image data that does not have unnecessary information added to compression processing according to the characteristics of each item of data. The compressed data generator 18 generates a single item of compressed data describing combining information for combining each item of data, together with each item of data after compression (step S39), and the processing is complete.

The divided shape image data and divided color image data is then chosen based on the state of the pixels denoting the character shapes contained in the divided shape image data. Compressed data is then generated according to the selection results. This enables compressed data to be generated in a more effective manner.

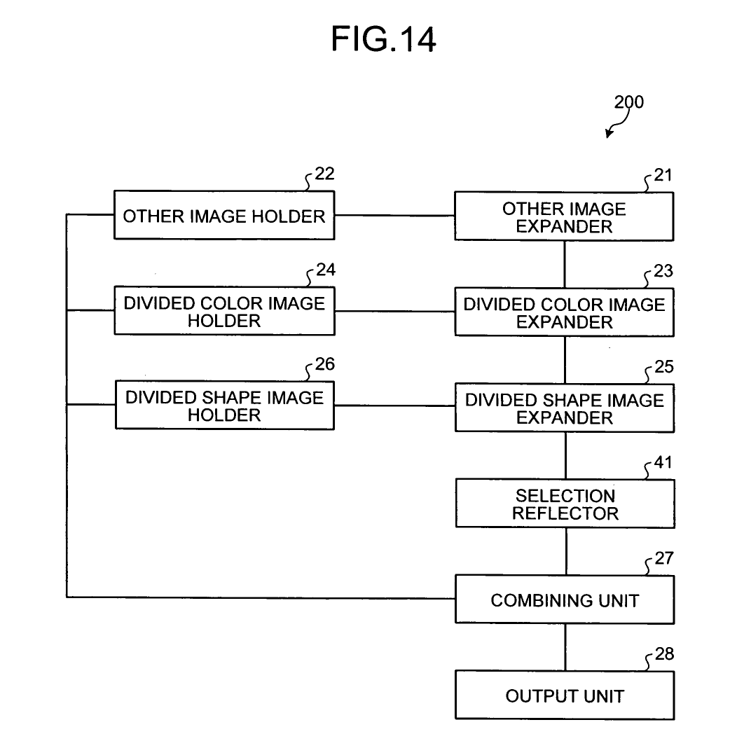

Next, combining of separated/divided images (other image data, divided color image data, and divided shape image data) is explained. FIG. 14 is a functional block diagram of the image processing apparatus 200 for combining separated/divided images.

As shown in FIG. 14, functional units for combining separated/divided images of the image processing apparatus 200 are basically similar to those of the image processing apparatus 100 except for a selection reflector 41.

The selection reflector 41 refers to the series of divided shape image data and divided color image data from the second storage unit 17, respectively, and controls the operation of the divided color image expander 23 and the divided shape image expander 25 in accordance with unnecessary information correlated with the divided shape image data and divided color image data.

Specifically, the selection reflector 41 sequentially refers to divided shape image data corresponding to one band region from the second storage unit 17. The divided shape image expander 25 is then controlled so that divided image data is not expanded for data that is determined to have correlated unnecessary information.

The selection reflector 41 sequentially refers to divided color image data corresponding to one band region from the divided color image holder 24. The divided color image expander 23 is then controlled so that divided color image data is not expanded for data that is determined to have correlated unnecessary information.

The selection reflector 41 then reflects the results of the image selection processing (step S36 in FIG. 12) by expanding the divided color image data and the divided shape image data, respectively, in accordance with unnecessary information given by the image selector 31. In the second embodiment, whether data is unnecessary is determined based on unnecessary information, but this can also be determined based on the presence of divided image data (divided color image data, divided shape image data) when the image selector 31 has deleted divided image data determined to be unnecessary.

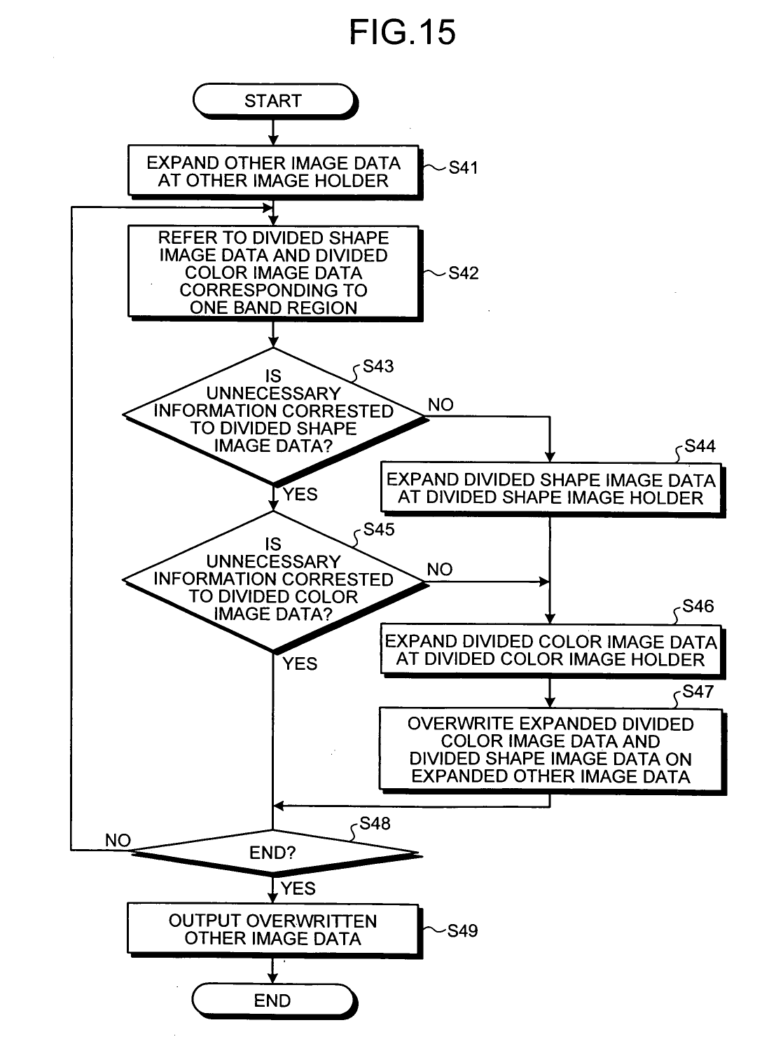

FIG. 15 is a flowchart of a procedure for separated/divided image combining processing performed by the image processing apparatus 200.

First, the other image expander 21 reads out other image data stored in the first storage unit 14 and expands the other image data at the other image holder 22 (step S41).

Next, the selection reflector 41 refers to divided shape image data and divided color image data corresponding to one band region constituting the other image data (step S42), and determines whether unnecessary information is correlated to the divided shape image data (step S43). When unnecessary information is not correlated to the divided shape image data (No at step S43), the divided shape image expander 25 reads out the divided shape image data from the second storage unit 17, expands the divided shape image data at the divided shape image holder 26 (step S44), and proceeds to step S46.

On the other hand, when unnecessary information is correlated with the divided shape image data (Yes at step S43), the selection reflector 41 determines whether unnecessary information is correlated to the divided color image data (step S45). When unnecessary information is correlated to the divided color image data (Yes at step S45), step S48 is proceeded to immediately.

When unnecessary information is not correlated to the divided color image data (No at step S45), the divided color image expander 23 reads out this divided color image data from the second storage unit 17 and expands the divided color image data at the divided color image holder 24 (step S46).

Next, the combining unit 27 refers to the divided shape image data expanded at the divided shape image holder 26, and overwrites the other image data expanded at the other image holder 22 with pixels for the divided color image data expanded at the divided color image holder 24 (step S47). When divided shape image data does not exist, i.e. when divided shape image data is not expanded at the divided shape image holder 26, only the divided color image data expanded at the divided color image expander 23 is written over the other image data.

The selection reflector 41 then determines at step S48 whether processing has been carried out for all the band regions making up the other image data. When it is determined that an unprocessed band region exists (No at step S48), step S42 is returned to again, and divided shape image data and divided color image data corresponding to the next band region are referred to from the second storage unit 17.

On the other hand, when the selection reflector 41 determines that processing is carried out for all the band regions making up the other image data (Yes at step S48), the output unit 28 outputs the other image data the divided color image data and the divided shape image data are overwritten on (step S49), and this processing ends.

In the above choosing of divided shape image data and divided color image data takes place based on the state of pixels expressing character shapes contained in divided shape image data. It is then possible to combine other image data, divided shape image data and divided color image data according to the results of this choice. This makes it possible to restore original input images more effectively.

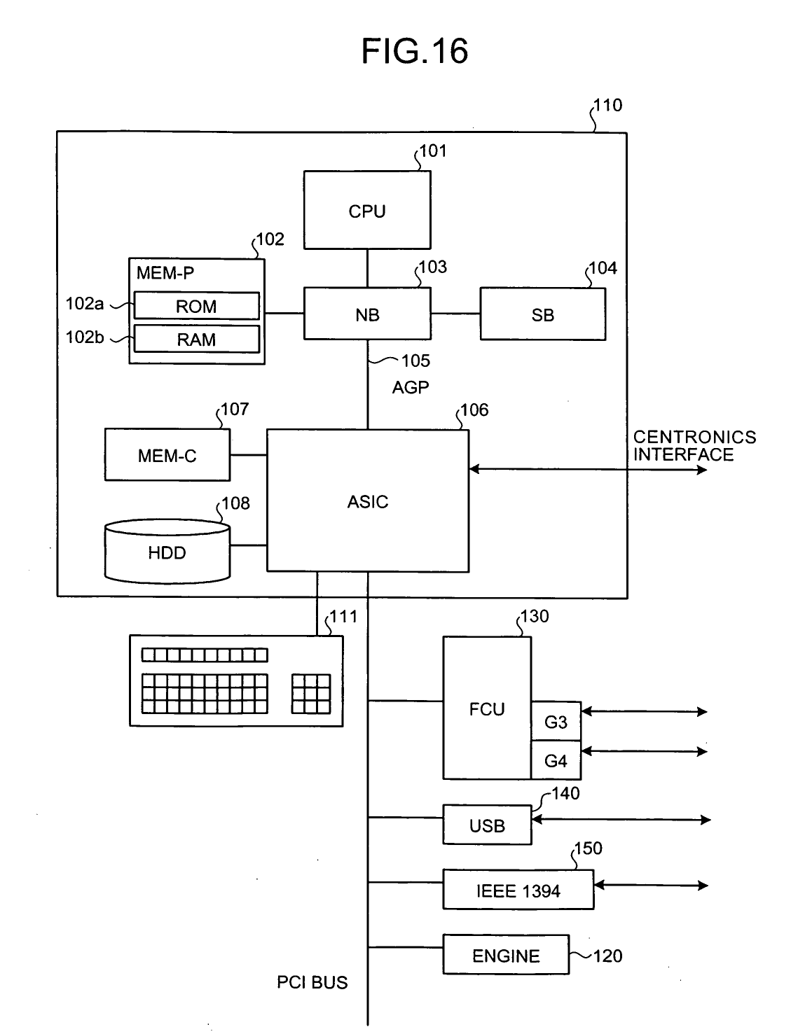

FIG. 16 is a block diagram of a hardware configuration of the image processing apparatus 100 (200). The image processing apparatus 100 (200) is, for example, a multifunction product (MFP) provided with a multitude of functions such as a fax function and a scanner function.

As shown in FIG. 16, the image processing apparatus 100 (200) includes a controller 110 and the engine 120 connected by a peripheral component interconnect (PCI) bus. The controller 110 controls the image processing apparatus 100 (200), and controls image forming, communication, and input from an operation unit 111. The engine 120 is a printer engine connectable to a PCI bus, and can be, for example, a black and white plotter, a single drum color plotter, a four-drum color plotter, or a scanner or facsimile unit. In addition to an engine portion such as a plotter, image processing such as for error diffusion and gamma conversion can also be included at the engine 120.

The controller 110 includes a CPU 101, a north bridge (NB) 103, a system memory (MEM-P) 102, a south bridge (SB) 104, an application specific integrated circuit (ASIC) 106, the MEM-C 107, and the HDD 108. An accelerated graphics port (AGP) bus 105 is connected across the NB 103 and the ASIC 106. The MEM-P 102 further includes the ROM 102a and the RAM 102b.

The CPU 101 controls the image processing apparatus 100 (200). The CPU 101 has a chip set including the NB 103, the MEM-P 102 and the SB 104 and is connected to other equipment via this chip set.

The NB 103 connects the CPU 101 and the MEM-P 102, the SB 104, and the AGP bus 105, and has a memory controller for controlling reading and writing of the MEM-P 102, a PCI master, and an AGP target.

The MEM-P 102 is system memory for storing computer programs and data, expanding computer programs and data, and printing an image on a printer, etc., and includes the ROM 102a and the RAM 102b. The ROM 102a is read-only memory for use as memory for storing computer programs and data. The RAM 102b is read-writable memory for expanding computer programs and data and printing an image on a printer.

The SB 104 connects the NB 103 and PCI devices and peripheral devices. The SB 104 is connected to the NB 103 via the PCI bus. A network interface (I/F) unit etc. is also connected to the PCI bus.

The ASIC 106 is an integrated circuit (IC) for image processing applications having hardware elements for image processing use and has the role of a bridge for respectively connecting the AGP bus 105, the PCI bus, the HDD 108 and the MEM-C 107. The ASIC 106 includes a PCI target and AGP master, an arbiter (ARB) central to the ASIC 106, a memory controller that controls the MEM-C 107, a number of direct memory access controllers (DMACs) that perform rotation etc. of image data using hardware logic etc., and a PCI unit for transferring data with the engine 120 via the PCI bus. A Fax control unit (FCU) 130, a universal serial bus (USB) 140, and an institute of electrical and electronics engineers 1394 (IEEE 1394) interface 150 are connected to the ASIC 106 via the PCI bus.

The MEM-C 107 is local memory used as an image buffer and code buffer for copy use. The HDD 108 stores therein computer programs, various types of data such as image data and font data, and forms.

The AGP bus 105 is a bus interface for graphics accelerator card use proposed in order to increase the speed of graphics processing. High-speed can then be achieved with a graphics accelerator card by then directly accessing the MEM-P 102 at a high throughput.

A computer program (hereinafter, “image processing program”) that implements the above image processing and is executed by the image processing apparatus 100 (200) are built-in in advance to the ROM 102a, the HDD 108, or the like.

The image processing program can also be provided recorded on a recording medium readable by a computer such as compact disc-read only memory (CD-ROM), flexible disc (FD), compact disc-recordable (CD-R), or digital versatile disk (DVD) as installable or executable files.

The image processing program can also be provided stored on a computer connected to a network such as the Internet or can also be downloaded via a network. The image processing program can also be provided and distributed via a network such as the Internet.

The image processing program has a module including each part (dividing size decider 12, image content separator 13, color/shape separator 15, color/shape divider 16, compressed data generator 18, other image expander 21, divided color image expander 23, divided shape image expander 25, combining unit 27, image selector 31, and selection reflector 41), with actual hardware of a CPU (processor) reading out and executing the image processing program from the ROM. Each part is then loaded into the main storage device to be implemented thereon.

The structural elements described in the above embodiments can be changed at stages of implementation. For example, several of the structural elements can be deleted from the whole of the structural elements shown in the embodiments. The structural elements can also be combined across different embodiments.

As set forth hereinabove, according to an embodiment of the present invention, it is possible to restrict the number of separated images without analyzing entire image data. Thus, separated and divided image data can be handled even with an apparatus having limited memory capacity. It is therefore possible to carry out more effective processing.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
a receiving unit that receives image data;
a deciding unit that decides a dividing size from a size of the image data and capacity of processing memory used in output processing of the image data;
a first separator that separates the image data into character image data including a character image and other image data including other image other than the character image;
a second separator that separates the character image data into shape image data denoting shape of the character image and color image data denoting color of the character image;
a dividing unit that divides the shape image data and the color image data based on the dividing size and creates a plurality of divided shape image data and a plurality of divided color image data; and
a generating unit that generates additional information for combining a corresponding pair of divided shape image data and divided color image data with the other image data.

2. The image processing apparatus according to claim 1, wherein the deciding unit takes one length of lengths in vertical direction and horizontal direction of the image data as being a fixed value, and decides a size for dividing another length as the dividing size.

3. The image processing apparatus according to claim 1, further comprising:
a first expanding unit that expands the other image data in the processing memory;
a second expanding unit that sequentially expands the divided shape image data in the processing memory;
a third expanding unit that sequentially expands the divided color image data corresponding to the divided shape image data in the processing memory; and
a combining unit that combines, based on the additional information, a corresponding pair of divided shape image data and divided color image data expanded in the processing memory with the other image data expanded in the processing memory to obtain combined data.

4. The image processing apparatus according to claim 3, further comprising a selecting unit that selects divided shape image data and divided color image data corresponding to the divided shape image data based on state of pixels contained in the divided shape image data, wherein
the combining unit combines the divided shape image data and the divided color image data with the other image data based on a selection result obtained by the selecting unit.

5. The image processing apparatus according to claim 3, further comprising an output unit that outputs the combined data.

6. The image processing apparatus according to claim 1, further comprising:
a compressing unit that subjects the other image data, the divided shape image data and the divided color image data to compression processing based on characteristics of respective data to generate compressed other image data, compressed divided shape image data and compressed divided color image data; and
a compressed-data generating unit that generates compressed data including the compressed other image data, a corresponding pair of the compressed divided shape image data and the compressed divided color image data, and compressed additional information for combining the corresponding pair with the compressed other image data.

7. The image processing apparatus according to claim 6, further comprising a selecting unit that selects divided shape image data and divided color image data corresponding to the divided shape image data based on state of pixels contained in the divided shape image data, wherein
the compressing unit performs the compression processing based on a selection result obtained by the selecting unit.

8. The image processing apparatus according to claim 4, wherein, upon determining that the divided shape image data does not contain a pixel indicating a character shape, the selecting unit determines that both the divided shape image data and the divided color image data corresponding to the divided shape image data are unnecessary.

9. The image processing apparatus according to claim 7, wherein, upon determining that the divided shape image data does not contain a pixel indicating a character shape, the selecting unit determines that both the divided shape image data and the divided color image data corresponding to the divided shape image data are unnecessary.

10. The image processing apparatus according to claim 4, wherein when a pixel indicating a character shape is contained in a whole region of the divided shape image data, the selecting unit determines that the divided image data is not necessary.

11. The image processing apparatus according to claim 7, wherein when a pixel indicating a character shape is contained in a whole region of the divided shape image data, the selecting unit determines that the divided image data is not necessary.

12. An image processing method comprising:
receiving image data;
deciding a dividing size from a size of the image data and capacity of processing memory used in output processing of the image data;
separating the image data into character image data including a character image and other image data including an image other than the character image;
separating the character image data into shape image data denoting shape of the character image and color image data denoting color of the character image;
dividing the shape image data and the color image data based on the dividing size and creates a plurality of divided shape image data and a plurality of divided color image data; and
generating additional information for combining a corresponding pair of divided shape image data and divided color image data with the other image data.

13. A computer program product comprising a computer usable medium having computer readable program codes embodied in the medium that, when executed, causes a computer to execute:
receiving image data;
deciding a dividing size from a size of the image data and capacity of processing memory used in output processing of the image data;
separating the image data into character image data including a character image and other image data including an image other than the character image;
separating the character image data into shape image data denoting shape of the character image and color image data denoting color of the character image;
dividing the shape image data and the color image data based on the dividing size and creates a plurality of divided shape image data and a plurality of divided color image data; and
generating additional information for combining a corresponding pair of divided shape image data and divided color image data with the other image data.
